(19) United States
(12) Patent Application Publication
(10) Pub. No.: US 2001/0011971 A1
(43) Pub. Date: Aug. 9, 2001

(54) REMOTE CONTROLLABLE MULTI PLANER DISPLAY UNIT

(76) Inventor: YOUNG W. KIM, ROSLYN, NY (US)

Correspondence Address: FRANK CHAU, DILWORTH & BARRESE, 333 EARLE OVINGTON BOULEVARD, UNIONDALE, NY, 11553

(21) Appl. No.: 09/118,107

(22) Filed: Jul. 17, 1998

(51) Int. Cl. G09G 3/04

(52) U.S. Cl. 345/33

(57) ABSTRACT

A display unit is disclosed which includes a first viewing side, a second viewing side and an illuminated price display on each of the first and second viewing sides. Each illuminated price display is formed with a plurality of digit fields. Each digit field on the first viewing side has a corresponding digit on the second viewing side, thereby forming digit field pairs which display congruous information. The display unit includes a remote control receiver which is responsive to a remote control transmitter for remotely changing the information displayed on one or more display units.

### BACKGROUND OF THE INVENTION

1. Field of the Invention

The present invention relates generally to electronic signs and more particularly relates to remotely controllable, multi planer display units well suited for use at gasoline filling stations.

2. Description of the Related Art

As with many commodity items, gasoline is a product whose retail price fluctuates. As gasoline prices change, these changes must be reflected on signs and displays which are posted at retail gasoline filling stations. These signs are generally located both at the pumps themselves and on large, elevated pole mounted displays for viewing by customers in vehicles traveling on the roadway.

Because gasoline prices change often, it is a desirable feature of these signs to be readily changeable by filling station employees. This is especially true of the elevated signs, where the use of ladders is often required to manually change prices which expose the workers to a fall hazard. U.S. Pat. No. 4,741,118 to Aiken et al. discloses a changeable sign which is adapted for pole mounted use. The sign disclosed by Aiken et al. includes a plurality of windows behind which are scrolling sign units with numeric indicia printed thereon. To display a price, a motor drives a scroll sign unit to the desired set point. U.S. Pat. No. 4,406,077 to Moon illustrates another electromechanical which is suitable for gas station use.

While these patents address the need for improved gas station display units, the disclosed electromechanical systems have short comings. For example these units are not visible at night without external illumination. Also, as these are electromechanical units, they are prone to failure. Further, while it is disclosed that these units can be altered by a remote control unit, such control units are physically connected by a wired connection to the displays and only control a single display face.

U.S. Pat. No. 4,064,555 to Ottenstein discloses a gasoline pump modification apparatus which includes electronically driven display numerals. Among other things, the electronically driven display numerals display the unit price of gasoline. However, these numerals are changed by switches which are physically located at the gasoline pump and only control a single display face. Therefore, changing the price displayed on the electronically driven display numerals is a somewhat labor intensive task. Accordingly, this system is not well suited for pole mounted use.

Accordingly, there remains a need for an improved display unit and system especially well suited for displaying the price of gasoline at retail filling stations.

### SUMMARY OF THE INVENTION

In accordance with one form of the present invention, a biplaner display unit has a first viewing side, a second viewing side and an illuminated display on each of the first and second viewing sides. The illuminated display is formed with a plurality of digit fields. Each digit field on the first viewing side has a corresponding digit on the second viewing side, thereby forming digit field pairs which display congruous information.

Preferably, the biplaner display unit includes a remote control receiver which is responsive to a remote control transmitter. Data from the remote control transmitter is received by the remote control receiver and is provided to the digit field pairs which change a numeric display in response thereto.

The first and second viewing sides are in opposition to each other. Such opposition can be direct (i.e., 180 degrees) or indirect (less than 180 degrees). The display unit can include a hinge member such that the degree of opposition of the first and second viewing sides can be adjusted at a retail facility in order to accommodate different viewing conditions.

In accordance with another form of the present invention, a display unit is formed with a plurality of viewing sides, each viewing side having a plurality of digit fields. Each of the plurality of viewing sides includes corresponding digit fields, thereby forming digit field groupings which display congruous information.

In a system formed in accordance with the present invention, multiple multi planer display units include a common identification number and are responsive to a single remote control transmitter. In this fashion, all display units at a retail facility can be changed in a single programming operation.

These and other objects, features and advantages of the present invention will become apparent from the following detailed description of illustrative embodiments thereof which is to be read in connection with the accompanying drawings.

### BRIEF DESCRIPTION OF THE DRAWINGS

The invention will be described in detail in the following description of preferred embodiments with reference to the following figures wherein:

FIG. 1 is a pictorial diagram of a first embodiment of a multi planer display unit mounted on a pole at a retail gasoline filling station;

FIG. 2 is a pictorial diagram of an alternate embodiment of a biplaner display unit mounted on a gasoline pump;

FIG. 3 is a block diagram of a biplaner display unit found in accordance with the present invention;

FIG. 4 is a flow chart illustrating an exemplary programming operation of a biplaner display unit formed in accordance with the present invention.

FIG. 5 is a top cross-sectional view of a biplaner display unit formed in accordance with the present invention, further illustrating a correspondence of digit fields on a first and second viewing side;

FIG. 6 is a diagram illustrating the construction of a plurality of digit display fields formed with a plurality of LEDs mounted and arranged on a printed circuit board;

FIG. 7 is a top cross-sectional view of an alternate embodiment of a biplaner display unit formed in accordance with the present invention; and

FIG. 8 is a top cross-sectional view of a multi planer display unit formed in accordance with the present invention.

### DETAILED DESCRIPTION OF PREFERRED EMBODIMENTS

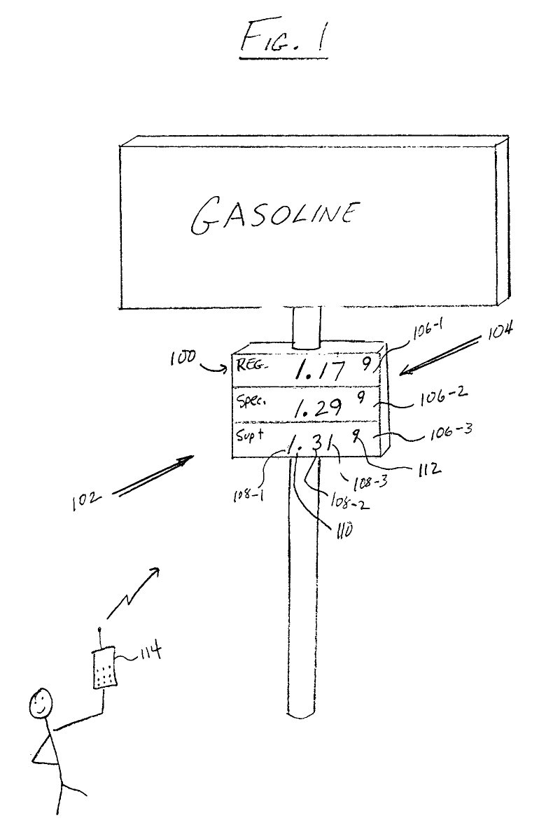

FIG. 1 illustrates an exemplary display unit 100 formed in accordance with the present invention. The display unit of FIG. 1 is configured as a biplaner, pole mounted gasoline price display sign. The display unit 100 has a first viewing side 102 and a second viewing side 104 each having at least one price field 106. In FIG. 1, the display unit has three price fields on each viewing side, with only those on the first viewing side being shown 106-1, 106-2, 106-3. Each price field 106 is formed with a plurality of digit fields 108. Generally, for the display of the price of gasoline, three digit fields 108-1, 108-2, 108-3 per price field 106 are sufficient, however, more or less price fields may be included. Preferably, a fixed decimal point display 110 is also included in each price field. Further, as it is customary to offer gasoline at a price increment of 0.9 cents per gallon, this is preferably included on each price field as a fixed indicia 112. The display unit 100 is preferably remote controlled as illustrated by an operator with a remote control transmitter 114.

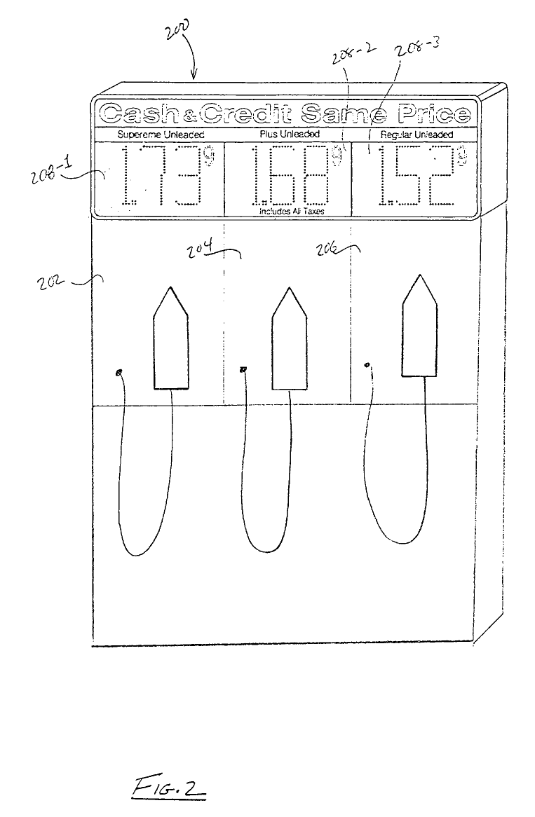

FIG. 2 illustrates an alternate embodiment of a display unit 200 which is mounted directly on a gasoline pumping station. The exemplary gasoline pumping station depicted includes three gasoline outlets per side, 202, 204, 206 and the display unit 200 includes three corresponding price fields 206-1, 206-2, 206-3 on each viewing side. However, display units with one, two and more price fields can also be formed to accommodate various pumping stations and are within the scope of the present invention.

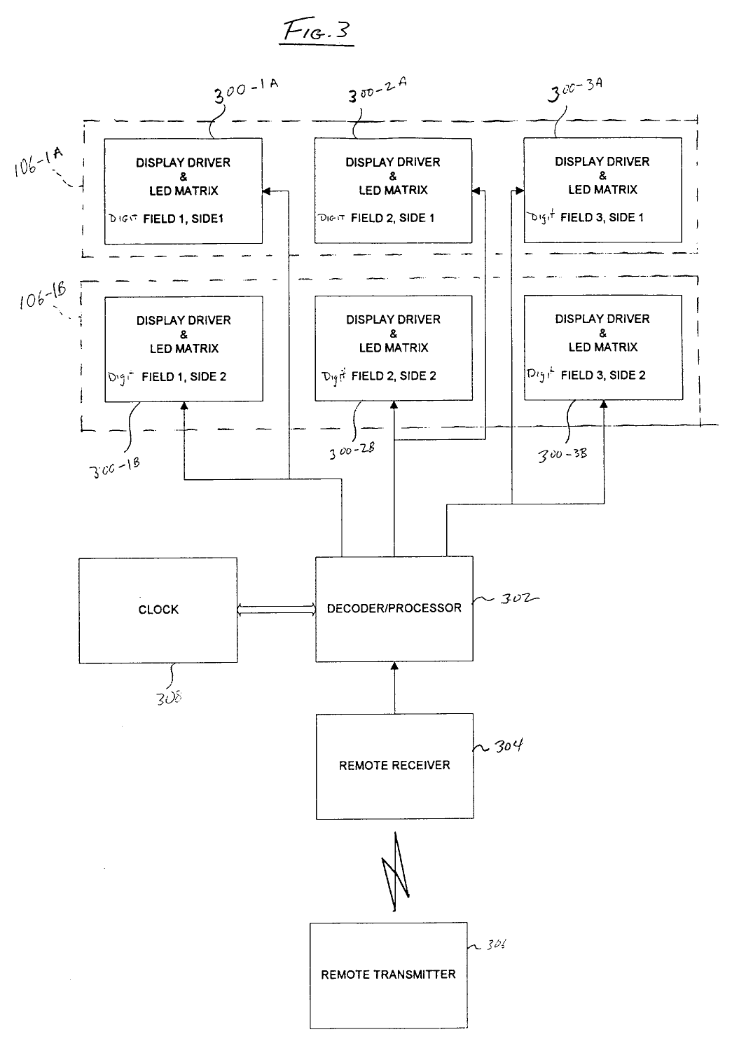

FIG. 3 is a block diagram further illustrating the construction of an exemplary biplaner display unit formed in accordance with the present invention. This embodiment illustrates a first price field 106-1A of the first viewing side 102 and a second price field 106-1B of the second viewing side 104. For each digit field 108, the display unit includes a digit display unit 300 which includes a display driver circuit and an illuminating display matrix capable of displaying numerals. (The decimal point display 10 is not shown in FIG. 3.) Accordingly, the price field 106-1A is formed with digit display units 300-1A, 300-2A and 300-3A and the price field 106-1B is formed with digit display units 300-1B, 300-2B and 300-3B.

The display unit further includes a decoder/processor circuit 302 which is coupled to a remote control receiver unit 304. Display data is provided to the receiver unit 304 by a remote transmitter unit 306. The receiver 304 and transmitter 306 are coupled by a remote communication medium such as radio frequency (RF), infrared (IR), ultrasonic and hard wire coupling. However, RF remote control is preferred for its omni directional nature and extended range.

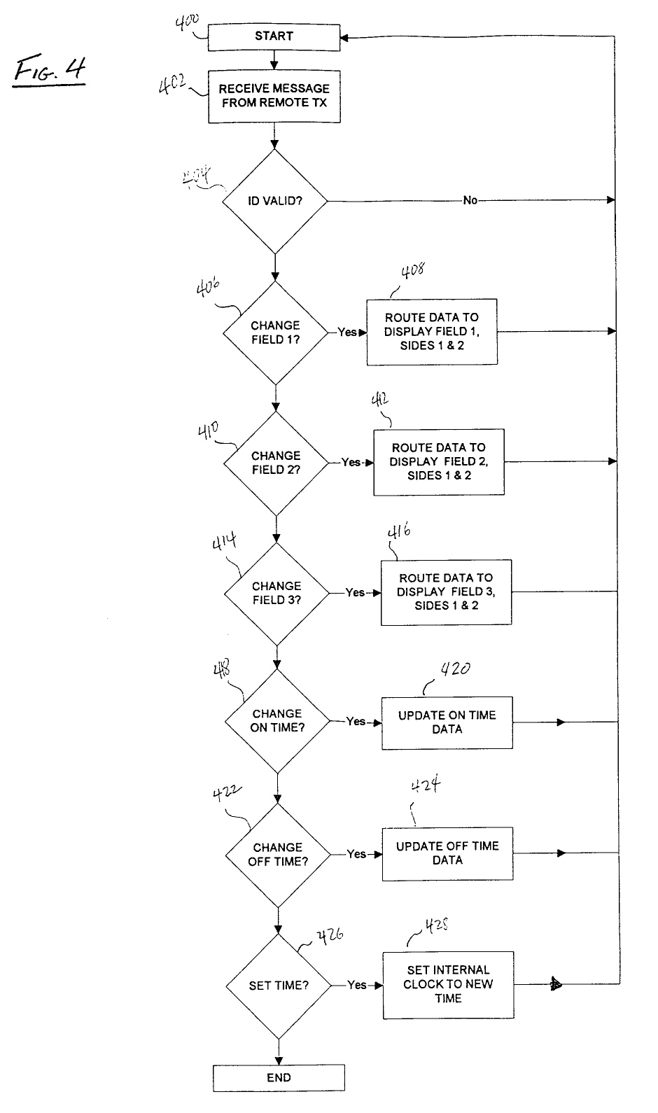

FIG. 4 illustrates an exemplary programming operation for the display unit of FIG. 3. Initially, data is received by the receiver unit 304 and is passed to the decoder/processor 302 (step 402). The decoder/processor 302 then determines if the received data is valid for that particular display unit (step 404). This is generally done by comparing an ID code in the received data to that associated with the display unit. The ID code in the display unit can be programmed in nonvolatile memory within the decoder/ processor 302 or it can be programmed by dip switches or other code programming means associated with the decoder/processor 302. If the received ID code does not match that of the display unit, the message is discarded and the display unit waits for the next received message.

If the data is valid, the decoder/processor 302 evaluates the received data to determine what action is to be taken. An important action to the present invention is to change the numeric display of the display unit 100. To change the displayed price, the received data specifies a price field, a digit field and a numeric value. While this minimum content is required, the exact format of the information in the message is not critical. Further, the numeric value can take the form of an increment or decrement command rather than an absolute value. When the decoder/processor 302 determines that the first field 300-1 of price field 106-1 is being changed, the display data is routed to digit display units 300-1A and 300-1B such that these digit display units illuminate with the same display information on the first viewing side 102 and second viewing side 104, respectively (Steps 406, 408). Accordingly, digit display units 300-1A and 300-1B are operated as a digit field pair. Similarly, digit display units 300-2A, 300-2B are operated as digit field pairs in steps 410 and 412 and digit display units 300-3A and 300-3B are operated as digit fields pairs in steps 414, 416.

In FIG. 3 the digit field pairs are shown physically coupled together. Alternatively, the digit display units 300 can be connected to a common bus structure and those digit display units forming digit field pairs can be virtually coupled by a common address or identification code.

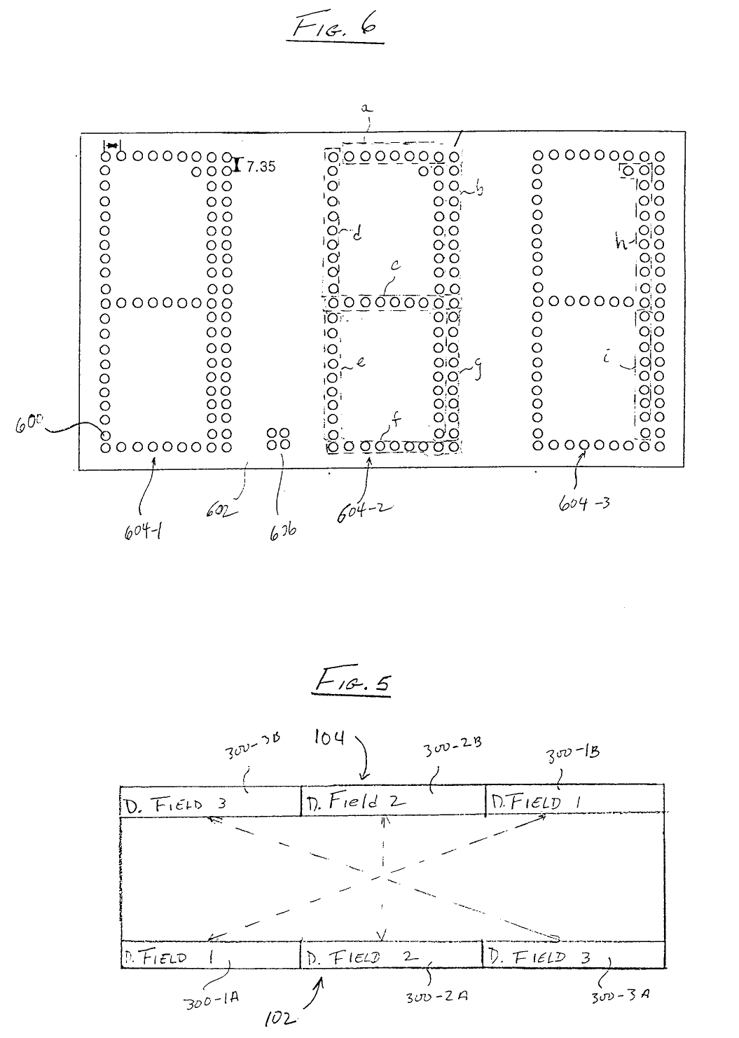

FIG. 5 illustrates a top cross sectional view of a biplaner display unit as formed in accordance with FIG. 3. In FIG. 5, the corresponding digit fields on the first viewing side 102 and second viewing side 104 are shown. The price field on the first viewing side 102 is formed with digit display units 300-1A, 300-2A and 300-3A arranged from left to right. Corresponding digit display units 300-1B, 300-2B and 300-3B are arranged from right to left to allow proper viewing from the second viewing side 104.

Returning to FIG. 3, the display unit 100 preferably includes a clock circuit 308 which is coupled to the decoder/processor circuit 302. The clock circuit 308, which preferably takes the form of a real time clock circuit, is used to automatically activate the display unit at a programmed “on” time and automatically turn “off” the display at a programmed off time. The on time, off time and correct current time can be programmed via the remote transmitter 306, as illustrated in FIG. 4.

Referring to FIG. 4, the decoder/processor 302 determines if a valid received message is received to change the programmed on time (step 418). If so, the on time, which is stored in memory in either the clock circuit 308 or decoder/processor 302, is updated to reflect the received data (step 420). Similarly, the programmed off time can be changed by a valid received message in steps 422, 424 and the current time in the clock circuit 308 can also be changed in steps 426, 428.

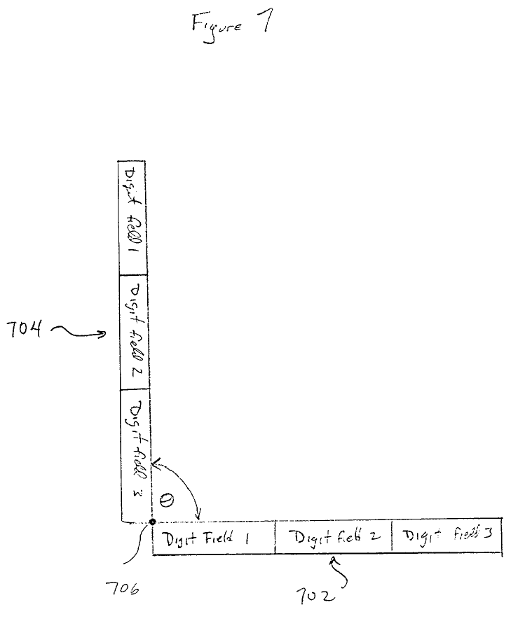

FIG. 6 illustrates a preferred display assembly for a price field formed with a plurality of light emitting diodes (LEDs) 600 mounted on a printed circuit board 602. The LEDs 600 are arranged as three digit matrices 604-1, 604-2, 604-3 and a decimal point display matrix 606. The digit matrices are formed such that the numbers 0-9 can be displayed by selectively illuminating LEDs 600 in the matrix. Preferably, the digit display units 300 include suitable decoding circuitry, such as read only memory, for performing this function. To simplify the display decoder circuitry, groups of LEDs 600 can be operated together with a common control line to form display segments a-g. In this way, a conventional seven-segment display driver can be used to form the digits 0-9 in each digit matrix 604. Preferably, supplemental segments h, i are active for the numbers 1 and 7. Conventional logic circuitry can be combined with a conventional seven segment display driver to activate these segments appropriately.

The use of individual LEDs to form display segments is preferred as it allows displays to formed of almost any size, including very large displays. However, other display elements can be used, such as incandescent bulbs in place of the LEDs and Liquid Crystal Display (LCD) panels can also be used. LED's are preferred in applications where their inherent brightness is required. LCD displays can be used in applications where the user is generally in closer proximity to the display and/or where the lower power dissipation of the LCD display is desired. Both LEDs and LCD displays have long mean time between failures which result in an easily readable display with a long life.

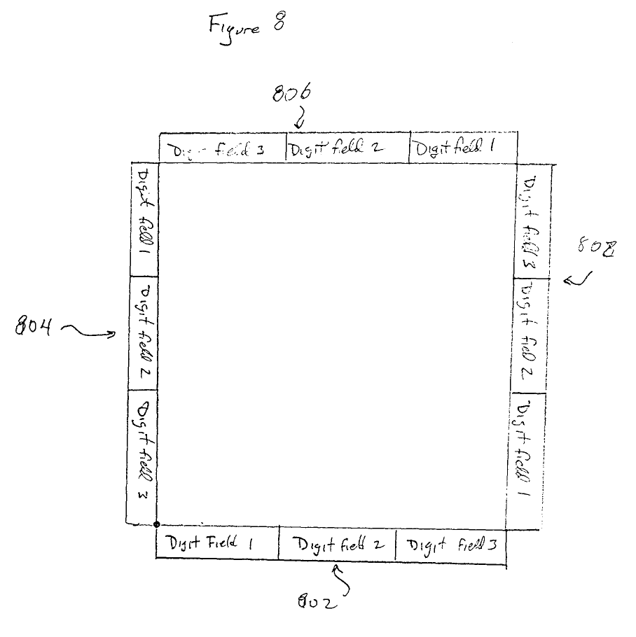

FIG. 7 illustrates an alternate embodiment of a biplaner display unit formed in accordance with the present invention. In this top cross-sectional view, a display unit includes a first viewing side 702 and a second side viewing 704. This unit is electrically equivalent to that of FIGS. 3 and 5, however, in this embodiment the first viewing side 702 and second viewing side 704 are arranged within an angular displacement which is other than direct opposition. The angle, θ, between the first and second viewing sides can be made to accommodate various viewing conditions. A hinge member 706 can also be included such that the angle can be made field adjustable.

FIG. 8 illustrates a multi planer display unit formed in accordance with the present invention. In FIG. 8, the display unit includes four viewing sides 802, 804, 806 and 808. Each viewing side includes at least one price field formed with a plurality of digit fields, in a similar manner to that previously described. However, in this embodiment, rather than digit fields being operated as digit field pairs, the digits are arranged as digit field quartets. Otherwise, the construction and operation of the display unit depicted in FIG. 8 is substantially an extended equivalent to that previously described.

The display units of the present invention are intended for outdoor use. Accordingly, the circuitry should be housed in an appropriate weatherproof enclosure. The viewing sides are preferably covered with a transparent plastic face suitably pigmented to emphasize the color of the LEDs. Alternatively, the face plate for the viewing sides can be formed from an opaque material with a plurality of perforations and light pipes coupled to the LEDs in order to facilitate viewing. When an LCD display is employed, the face plate should be a clear transparent member.

In a typical retail gasoline setting, there are many gasoline pumping stations each with a display unit as illustrated in FIG. 2 and one or more pole mounted display units as shown in FIG. 1. In such a setting, each display unit can be programmed with a common identification code for that retail facility such that when an operator wishes to change the price displayed, a single command will alter the price of all display units at that facility. The number of display units which can be programmed simultaneously is only limited by the range and directional nature of the remote control transmitter and receiver used in a display unit. Accordingly, RF is the referred remote control medium as it provides extended range and an omni directional character.

Having described embodiments of the present invention, it is noted that modifications and variations can be made by persons skilled in the art in light of the above teachings. It is therefore to be understood that changes may be made in the particular embodiment of the invention disclosed which are within the scope and spirit of the invention as outlined by the appended claims.

What is claimed is:

1. A multi planer illuminated display unit comprising:
a first viewing side having an illuminated display including a first plurality of digit fields;
a second viewing side having an illuminated display including a second plurality of digit fields, said first plurality of digit fields corresponding to said second plurality of digit fields, thereby forming digit field pairs displaying congruous information.

2. A multi planer illuminated display unit, as defined by claim 1, further comprising:
a remote control transmitter; and
a remote control receiver responsive to said remote control transmitter and providing display data to the digit field pairs.

3. A multi planer illuminated display unit, as defined by claim 1, wherein said digit fields include a plurality of light emitting diodes arranged for numeric display.

4. A multi planer illuminated display unit, as defined by claim 1, wherein said digit fields include a liquid crystal display element for numeric display.

5. A multi planer illuminated display unit, as defined by claim 1, wherein said first viewing side and said second viewing side oppose each other by 180 degrees.

6. A multi planer illuminated display unit, as defined by claim 1, further comprising a weather proof enclosure housing said display unit, said housing including means for mounting said display unit on an elevated pole.

7. A display unit for gasoline pumping stations having a plurality of dispensing outlets, the display unit comprising:
a first viewing side having an illuminated display including a first plurality of price fields corresponding to the plurality of dispensing outlets, each price field including a plurality of digit fields;
a second viewing side having an illuminated display including a second plurality of price fields corresponding to the plurality of dispensing outlets, each price field including a plurality of digit fields, said first plurality of price fields corresponding to said second plurality of price fields, thereby forming price field pairs displaying congruous information on said first and second viewing sides for each dispensing outlet.

8. A display unit as defined by claim 7, further comprising:
a remote control transmitter; and
a remote control receiver responsive to said remote control transmitter and providing display data to the price field pairs.

9. A display unit as defined by claim 7, wherein said digit fields include a plurality of light emitting diodes arranged for numeric display.

10. A display unit as defined by claim 7, wherein said digit fields include a liquid crystal display for numeric display.

11. A display unit as defined by claim 8, wherein said first viewing side and said second viewing side oppose each other by 180 degrees.

12. A display unit as defined by claim 8, further comprising a weather proof enclosure housing said display unit, said housing including means for mounting said display unit on the gasoline pumping station.

13. A multi planer illuminated display unit comprising:
a first plurality of display matrices forming a first viewing side;
a first plurality of display matrix drivers coupled to said first plurality of display matrices;
a second plurality of display matrices forming a second viewing side;
a second plurality of display matrix drivers coupled to said second plurality of display matrices; and
a controller, said controller being coupled to said first and second plurality of display matrix drivers and providing congruous display data thereto.

14. A multi planer illuminated display unit as defined by claim 13, further comprising:
a remote control transmitter for transmitting display data from a user; and
a remote control receiver responsive to said remote control transmitter, said remote control receiver being coupled to said controller and providing said display data.

15. A multi planer illuminated display unit as defined by claim 14, wherein said controller has an associated identification code and wherein said remote control transmitter appends said identification code to said display data prior to transmitting said data.

16. A multi planer illuminated display unit as defined by claim 15, further comprising a programmable clock unit, said clock unit providing a control signal to enable said display matrices at a first time and disable said display matrices at a second time.

17. A multi planer illuminated display unit as defined by claim 16, wherein said clock unit is operatively coupled to said controller and wherein said first time and said second time are programmable by a user via said remote control transmitter.

18. A multi planer illuminated display unit as defined by claim 17, wherein said display matrices are formed with a plurality of light emitting diodes.

19. A multi planer illuminated display unit as defined by claim 17, wherein said display matrices are formed with a liquid crystal display.

20. A display system for a gasoline filling station comprising:
a remote control transmitter providing price display data from a user and an identification code;
at least two display units, said display units including:
a first viewing side having an illuminated display including a first plurality of digit fields;
a second viewing side having an illuminated display including a second plurality of digit fields, said first plurality of digit fields corresponding to said second plurality of digit fields, thereby forming digit field pairs displaying congruous information in response to received display data having said identification code; and
a remote control receiver responsive to said remote control transmitter and providing said display data to the digit field pairs.
